(19) United States
(12) Patent Application Publication
(10) Pub. No.: US 2023/0380590 A1
(43) Pub. Date: Nov. 30, 2023

(54) FURNITURE FITTING AND METHOD FOR PRODUCING A FURNITURE FITTING

(71) Applicant: Julius Blum GmbH, Hoechst (AT)

(72) Inventor: Stefan HAID, Fussach (AT)

(21) Appl. No.: 18/229,244

(22) Filed: Aug. 2, 2023

Related U.S. Application Data
(63) Continuation of application No. PCT/AT2022/060034, filed on Feb. 3, 2022.

(30) Foreign Application Priority Data
Feb. 11, 2021 (AT) A 50087/2021

(51) Int. Cl. A47B 88/423; F16B 12/08

(52) U.S. Cl. CPC A47B 88/423; F16B 12/08

(57) ABSTRACT

A method for producing a furniture fitting for movably supporting at least one furniture part on a furniture carcass includes, preferably in the specified order chronologically consecutive, providing a, preferably plate-shaped, base body, introducing a, preferably cylindrical, opening in the base body, the opening having a collar surrounding the opening, and the collar protruding from the base body, at least partially heating the collar, and widening the collar in a heated condition by mechanical forming in at least one radial direction to a, preferably ring-shaped, bulge.

### BACKGROUND OF THE INVENTION

The present invention relates to a method for producing a furniture fitting for movably supporting at least one furniture part on a furniture carcass. Further, the invention concerns a furniture fitting of the type to be described.

The hinged connection between two components of a furniture fitting is frequently established such that each the components is provided with an opening. Subsequently, a pin is passed through the openings of the two components, and then at least one end of the pin is widened by means of a clinching operation. In this way, the two components can be fixed relative to one another in an axial direction of the pin.

A drawback is the fact that the costs for producing the furniture fitting are increased, in particular when a large number of pins is arranged. Moreover, with a cold-forming process such as the clinching operation, there is the danger that cracks may be formed on the pin. If these cracks are detected at an early stage by an optical detection system or by spot-check examinations, then the pin can be immediately replaced. However, smaller hairline fractures of the pin frequently remain unnoticed, and can lead to a breakage of the connection between the components of the furniture fitting at a later point of time.

### SUMMARY OF THE INVENTION

It is an object of the present invention to provide a method for producing a furniture fitting and to provide and an improved furniture fitting, thereby avoiding the above-discussed drawbacks.

The method for producing a furniture fitting for movably supporting at least one furniture part on a furniture carcass includes the following, preferably in the specified order chronologically consecutive, method steps:
at least one, preferably plate-shaped, base body is provided in a first method step,
at least one, preferably cylindrical, opening is introduced in the at least one base body in a second method step, the opening having at least one collar surrounding the opening, wherein the at least one collar protrudes from the at least one base body,
the at least one collar is at least partially heated in a third method step, and
the at least one collar, in a heated condition, is widened by mechanical forming in at least one radial direction to a, preferably ring-shaped, bulge in a fourth method step.

Accordingly, a base body is provided in a first method step. For example, the base body can be produced by punching from a, preferably flat, sheet metal, preferably made of steel.

The material thickness of the flat base body can preferably lie between 0.5 mm and 1.0 mm.

In a second method step, an opening is introduced into the base body, and a collar is formed. The collar forms a pivot bearing having an increased supporting surface. For example, the collar can be produced by collar forming. The opening in the base body can be formed by a bore for example.

In a third method step, the collar, preferably the free end of the collar, is locally heated. For example, the heating can be implemented by a rapidly rotating tool which is to be pressed against the collar. Due to the occurring friction, the material of the collar can be plasticized, that is to say brought into a deformable or flowable condition.

In a fourth method step, the collar is deformed in a heated condition, and a widened bulge is formed. By applying an axial force to the collar and due to the high rotational speed of the tool, the material of the collar is urged in a radial direction, and a characteristic bulge is produced. By virtue of the bulge, the components of the furniture fitting to be connected to each other can be fixed to one another in an axial direction of the collar.

By the proposed method, several advantages can be provided. Firstly, additional fixing means (for example a pin) for connecting the two components of the furniture fitting can be omitted so as to significantly reduce the costs in the serial production of the furniture fitting.

Accordingly, an own supply station for providing additional fastening means, in particular pins, can be omitted in the factory.

Due to the occurring heat treatment, also a defined and chipless shaping, a higher resistance of the collar, and a smooth surface of the produced bulge can be obtained. Ultimately, a characteristic, torus-shaped bulge on the free end of the collar can be present.

The collar can discolor in the heated region due to the supply of heat in the course of the third method step (for example in the form of a black coloration or a blue coloration). As a result, special visual effects can be provided. For example, the base body of the furniture fitting can have a conventional zinc color, whereas the rotational axes of the furniture drive are blackened on both ends due to the heating.

The furniture fitting according to the invention includes at least one, preferably plate-shaped, base body. The at least one base body includes at least one, preferably cylindrical, opening having at least one collar surrounding the opening, and the at least one collar protrudes from the at least one base body. The at least one collar includes at least one, preferably ring-shaped, bulge extending in at least one radial direction. Preferably, the furniture fitting is produced by the described method.

### BRIEF DESCRIPTION OF THE DRAWINGS

Further details and advantages of the present invention result from the following description of figures.

FIG. 1a-1d show a schematic illustration of the method for producing a furniture fitting in subsequent method steps,

FIG. 2 shows a perspective view of an exemplary furniture fitting for releasably connecting a drawer front panel to a drawer sidewall,

FIG. 3a-3c show the furniture fitting according to FIG. 2 in a perspective view and two different detail views thereof,

FIG. 4a, 4b show two different views of the base body of the furniture fitting with the collar in an undeformed condition and in a deformed condition, in which the free end of the collar includes a widened bulge,

FIG. 5a-5c show a perspective view of a furniture fitting in a slightly modified embodiment and two enlarged detail views thereof, in which the bulge is formed after the arrangement of the pivotable component.

### DETAILED DESCRIPTION OF THE INVENTION

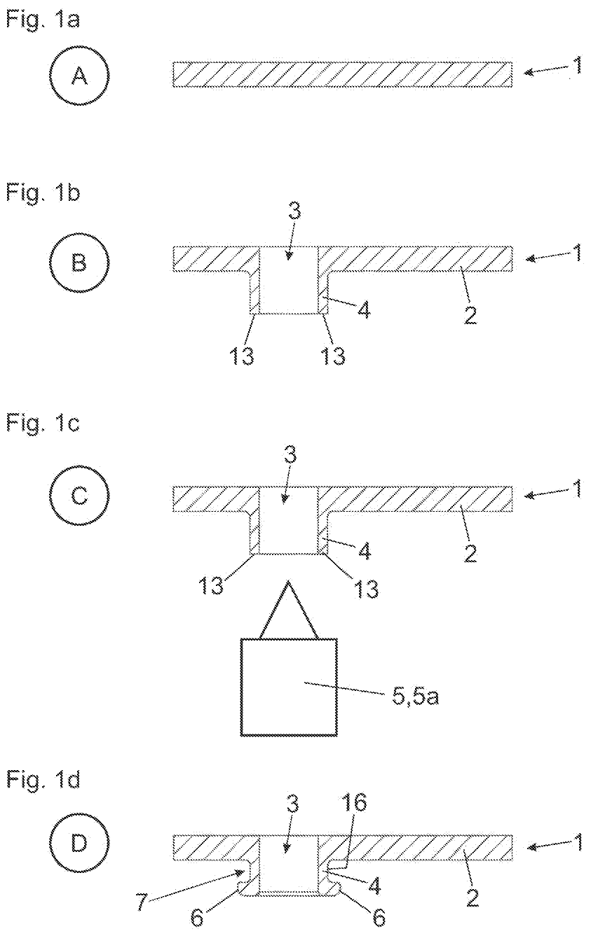

FIG. 1a-1d show the method for producing a furniture fitting 1 in different method steps, namely
in a first method step (A), at least one, preferably plate-shaped, base body 2 is provided (FIG. 1a),
in a second method step (B), at least one, preferably cylindrical, opening 3 is introduced in the at least one base body 2, the opening 3 having at least one collar 4 surrounding the opening 3, wherein the at least one collar 4 protrudes from the at least one base body 2, preferably the collar 4 having a front face 13 (FIG. 1b),
in a third method step (C), the at least one collar 4 is at least partially heated, preferably by a heating source 5, particularly preferable by a rotating tool 5a (FIG. 1c), and
in a fourth method step (D), the at least one collar 4, in a heated condition, is widened by mechanical forming, preferably by the rotating tool 5a, in at least one radial direction to a, preferably ring-shaped, bulge 6 (FIG. 1d).

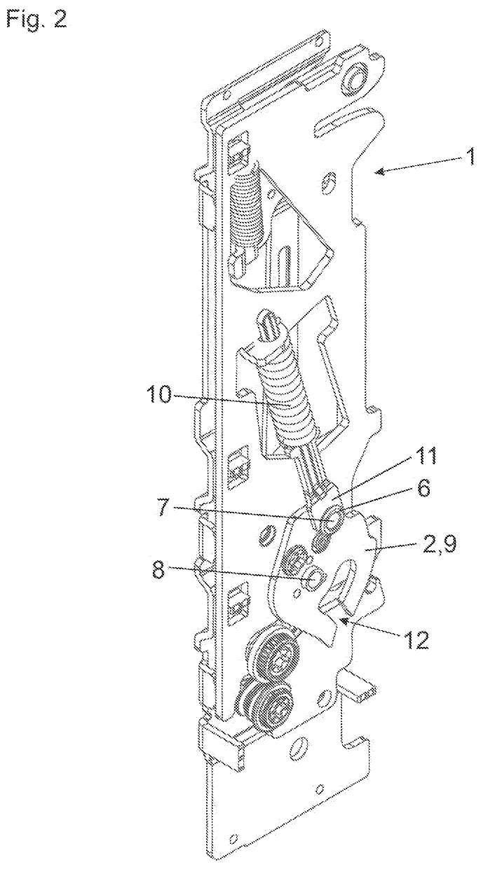

According to FIG. 1d, the furniture fitting 1 forms a, preferably partially cylindrical, bearing location 7 for a component 11 (FIG. 2) of the furniture fitting 1. In a mounted condition, the component 11 of the furniture fitting 1 is partially received between the base body 2 and the bulge 6 on a hollow-cylindrical portion 16 of the collar 4, and is pivotally supported on an axis formed by the collar 4.

Accordingly, an additional arrangement of fastening means, in particular pins, can be thus omitted.

FIG. 2 shows a perspective view of a furniture fitting 1 which, in the shown embodiment, is configured to releasably lock a drawer front panel to a drawer sidewall.

In a mounted condition, the furniture fitting 1 is arranged on a front-end of the drawer sidewall and usually includes a catch element 9 with a catch opening 12, the catch element 9 being pivotable about a pivoting axis 8. In the shown embodiment, the catch element 9 corresponds to the base body 2.

On the rear side of the drawer front panel, a holding portion (not shown here) is to be mounted. The catch element 9 can be triggered by an entry of the holding portion into the catch opening 12, and the catch element 9 (jointly with the holding portion coupled therewith) can be retracted by a force of a force storage member 10. In this way, the drawer front panel can be pressed against the front face of the drawer sidewall. Such furniture fittings 1 are basically well-known in their structure and need not to be described in greater detail here.

The force storage member 10, for example in the form of a helical spring configured as a compression spring, presses via the component 11 against the bearing location 7 of the furniture fitting 1. The component 11 is pivotally supported on the bearing location 7. It can be seen that the component 11 is partially received between the base body 2 (that is to say the catch element 9) and the bulge 6. In this way, the position of the component 11 can be fixed in a direction extending in an axial direction of the bearing location 7.

However, it is in no way strictly necessary that the component 11 entirely embraces the bearing location 7, in particular the hollow-cylindrical portion 16 (FIG. 1d), and is thus undetachably connected to the bearing location 7. Instead, the component 11 can have a clamp-shaped portion configured to releasably connect the component 11 to the bearing location 7. For releasing the connection between the component 11 and the bearing location 7, it is sufficient to move the component 11 against a force of the force storage member 10 and to separate the clamp-shaped portion of the component 11 from the bearing location 7.

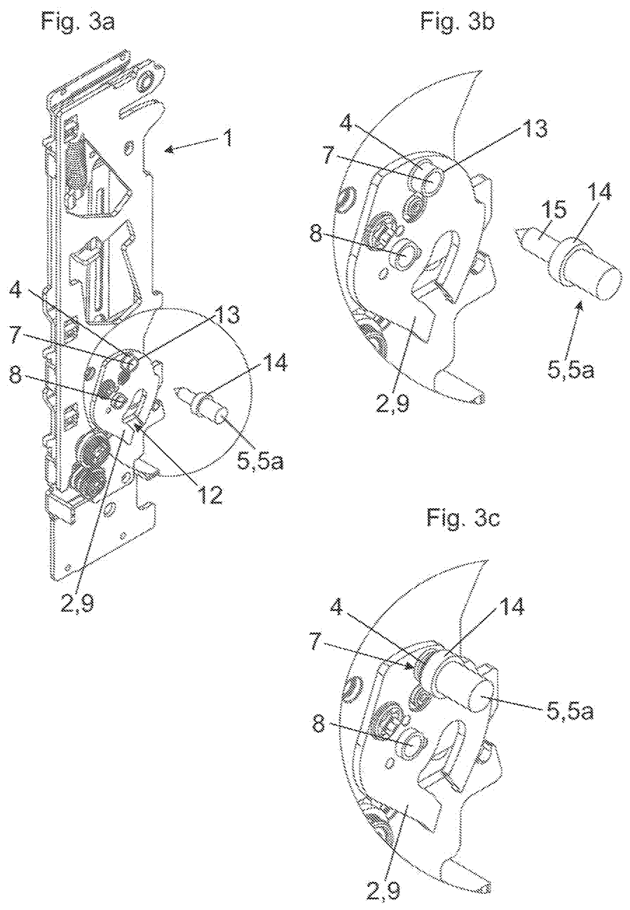

FIG. 3a-3c show the furniture fitting 1 according to FIG. 2 in a perspective view, and two different detail views thereof.

In FIG. 3a, the furniture fitting 1 can be seen, in which the collar 4 protruding transversely from the base body 2 has already been produced in the course of the first and second method steps. The collar 4 is configured to be partially cylindrical and includes a front face 13 facing away from the base body 2.

In the course of the third method step, the collar 4 is heated, at least on the front face 13, by a heating source 5, preferably by the rotating tool 5a.

FIG. 3b shows the encircled region of FIG. 3a in an enlarged view. The rotating tool 5a includes a centering pin 15 and a ring-shaped elevation 14. Such a tool 5a can include, for example, as so-called flow drill. The flow drill is to be rotated with high speed and is to be at least partially introduced into the at least one collar 4 and/or into the opening 3.

The ring-shaped elevation 14 of the tool 5a is to be contacted in the course of the third method step with the at least one collar 4, preferably with the front face 13 of the collar 4.

FIG. 3c shows the tool 5a introduced into the collar 4, and the bulge 6 (FIG. 2) is formed in the course of the fourth method step by means of the tool 5a. By virtue of the tool 5a, a pressure is to be applied in an axial direction of the collar 4. In this way, the bulge 6 can be formed on an end of the collar 4 in the course of the fourth method step, the end of the collar 4 being spaced from the at least one base body 2.

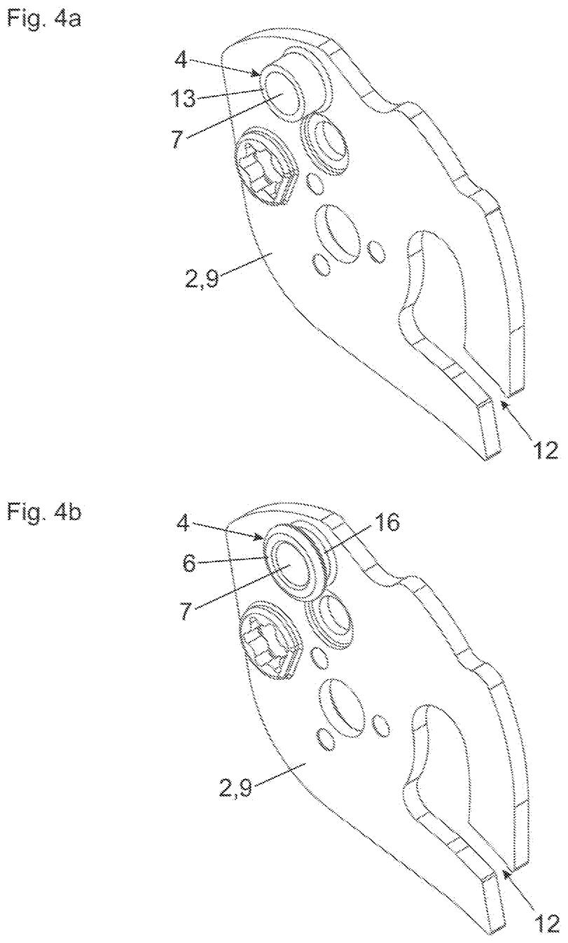

On the collar 4, at least one hollow-cylindrical portion 16 (FIG. 1d, FIG. 4b) remains between the bulge 6 and the base body 2, the hollow-cylindrical portion 16 having a smaller diameter than the bulge 6. The hollow-cylindrical portion 16 of the collar 4 serves for the, preferably pivotal, support of the component 11 of the furniture fitting 1.

FIG. 4a shows the base body 2 (catch element 9) and the collar 4 protruding transversely from the base body 2, the collar 4 being in an undeformed condition. Due to the rotating tool 5a, the front face 13 of the collar 4 is heated such that the material of the collar 4 can be transferred into a plasticized condition.

FIG. 4b shows the base body 2 (catch element 9) with the collar 4 protruding transversely from the base body 2, the collar 4 being in a deformed condition. By pressing the tool 5a against the front face 13 of the collar 4 and due to the high rotational speed of the tool 5a, the collar 4 is widened in a radial direction to a, preferably ring-shaped, bulge 6.

At least one hollow-cylindrical portion 16 remains between the bulge 6 and the base body 2, the at least one hollow-cylindrical portion 16 having a smaller diameter than the bulge 6.

The pivotable component 11 can either be arranged immediately on the bearing location 7 after the production of the collar 4, and the bulge 6 is subsequently produced. In a mounted condition, the component 11 is partially received between the base body 2 and the bulge 6.

Alternatively, the component 11 can also be arranged on the bearing location 7 after the production of the bulge 6. This can be implemented, for example, by a clamp of the component 11, the clamp only partially embracing the hollow-cylindrical portion 16.

Therefore, the component 11 can also be releasably connected to the bearing location 7 after the production of the bulge 6.

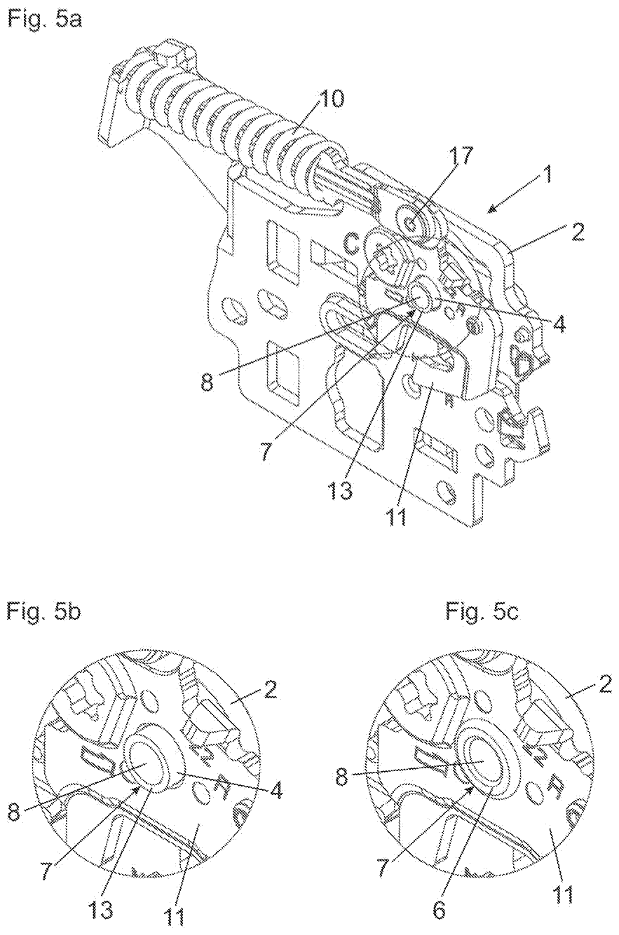

FIG. 5a shows a perspective view of the furniture fitting 1 according to a slightly modified embodiment, in which the bulge 6 of the bearing location 7 is formed after the arrangement of the pivotable component 11.

The force storage member 10 is pivotally connected via the hinge axis 17 to the pivotable component 11, the pivotable component 11 being pivotable about the pivoting axis 8.

In a first and second method step, the base body 2 with the collar 4 is firstly provided. In a further method step, the component 11 is pivotally arranged on the collar 4.

FIG. 5b shows the encircled region of FIG. 5a in an enlarged view, in which the component 11 is pre-positioned on the collar 4 of the bearing location 7.

FIG. 5c shows the region of the bearing location 7, after the collar 4 has been heated in a third method step and has been deformed to a, preferably ring-shaped, bulge 6 in a fourth method step. In a mounted condition, the pivotable component 11 is pivotally supported about the pivoting axis 8 of the bearing location 7, and is partially received between the base body 2 and the bulge 6.

The present invention has been described in the figures with the aid of the furniture fitting 1 for releasably connecting a drawer front panel to the drawer sidewall. Of course, the furniture fitting 1 can also be configured as a furniture drive for moving a furniture flap, as a furniture hinge for movably supporting a furniture part, or as a drawer pull-out guide.

1. A method for producing a furniture fitting for movably supporting at least one furniture part on a furniture carcass, the method comprising the following, preferably in the specified order chronologically consecutive, method steps:
at least one, preferably plate-shaped, base body is provided in a first method step,
at least one, preferably cylindrical, opening is introduced in the at least one base body in a second method step, the opening having at least one collar surrounding the opening, wherein the at least one collar protrudes from the at least one base body,
the at least one collar is at least partially heated in a third method step, and
the at least one collar, in a heated condition, is widened by mechanical forming in at least one radial direction to a, preferably ring-shaped, bulge in a fourth method step.

2. The method according to claim 1, wherein the at least one base body, in the course of the first method step, is provided by punching from a, preferably flat, sheet metal, preferably made of steel.

3. The method according to claim 1, wherein the at least one collar, in the course of the second method step, is produced by collar forming, and/or the at least one opening is formed in the base body by drilling in the course of the second method step.

4. The method according to claim 1, wherein the at least one collar is discolored in the heated region in the course of the third method step.

5. The method according to claim 1, wherein the at least one collar has at least one front face, wherein the at least one collar is heated at least on the at least one front face in the course of the third method step.

6. The method according to claim 1, wherein the at least one collar is heated by at least one rotating tool in the course of the third method step.

7. The method according to claim 6, wherein the tool is at least partially introduced into the at least one collar and/or into the at least one opening.

8. The method according to claim 6, wherein the tool includes at least one ring-shaped elevation which is brought into contact with the at least one collar in the course of the third method step.

9. The method according to claim 1, wherein the bulge is formed by means of at least one tool in the course of the fourth method step, wherein a pressure is applied in at least one axial direction of the at least one collar by the at least one tool.

10. The method according to claim 1, wherein the bulge is formed on an end of the collar in the course of the fourth method step, the end of the collar being spaced from the at least one base body.

11. The method according to claim 1, wherein in the course of the fourth method step, at least one hollow-cylindrical portion remains on the collar between the bulge and the base body, the at least one hollow-cylindrical portion having a smaller diameter than the bulge.

12. The method according to claim 1, wherein at least one further component of the furniture fitting is, preferably pivotally, supported on the at least one collar.

13. A furniture fitting for movably supporting at least one furniture part on a furniture carcass, the furniture fitting comprising at least one, preferably plate-shaped, base body, wherein the at least one base body includes at least one, preferably cylindrical, opening having at least one collar surrounding the opening, wherein the at least one collar protrudes from the at least one base body, wherein the at least one collar includes at least one, preferably ring-shaped, bulge extending in at least one radial direction, preferably wherein the furniture fitting is produced by means of a method according to claim 1.

14. The furniture fitting according to claim 13, wherein the at least one base body is configured as a punching portion.

15. The furniture fitting according to claim 13, wherein the at least one bulge has a discolor deviating from the color of the base body.

16. The furniture fitting according to claim 13, wherein the at least one bulge is formed on an end of the collar, the end of the collar being spaced from the at least one base body.

17. The furniture fitting according to claim 13, wherein at least one hollow cylindrical portion is arranged on the collar between the bulge and the base body, the at least one hollow cylindrical portion having a smaller diameter than the bulge.

18. The furniture fitting according to claim 13, wherein at least one further component is, preferably pivotally, supported on the at least one collar.

19. The furniture fitting according to claim 13, wherein the furniture fitting is configured as a furniture drive for moving a furniture flap, as a furniture hinge for movably supporting a furniture part, or as a drawer pull-out guide.
